(19) United States
(12) Patent Application Publication
(10) Pub. No.: US 2026/0163774 A1
(43) Pub. Date: Jun. 11, 2026

(54) MULTI-RATE QUADRATURE PHASE SHIFT KEYING

(71) Applicant: Rockwell Collins, Inc., Cedar Rapids, IA (US)

(72) Inventor: Benjamin Peiffer, Cedar Rapids, IA (US)

(21) Appl. No.: 18/975,557

(22) Filed: Dec. 10, 2024

(51) Int. Cl. H04L 27/20

(52) U.S. Cl. CPC H04L 27/2082

(57) ABSTRACT

A communication system and modulator for multiplexing two RF functions onto a shared antenna use a quadrature phase shift keying scheme (QPSK) scheme where each function is modulated using a binary PSK (BPSK) modulation and rotated onto a virtual axis before being combined. A transition enabler determines when the lower rate RF function is permitted to transition between binary states. When the higher rate RF function is repeated for a given cycle, the lower rate RF function may not interfere, and is allowed to transition. RF functions may be scaled according to the priority of each signal.

### BACKGROUND

Physical limits on the amount of aperture space available on airborne platforms, as well as limited radio spectrum availability, requires increasing spectrally efficiency. Execution of two or more radio frequency (RF) functions with the same frequency assignment is often managed by a shared scheduler. The use of a shared scheduler often results in unpredictable degradation in the quality of service of individual functions.

It would be advantageous to have a modulation method for multiplexing RF functions with the same frequency assignment, on a shared antenna, without quality degradation.

### SUMMARY

In one aspect, embodiments of the inventive concepts disclosed herein are directed to a communication system and modulator for multiplexing two RF functions onto a shared antenna using a quadrature phase shift keying scheme (QPSK) scheme. Each function is modulated using a binary PSK (BPSK) modulation and rotated onto a virtual axis before being combined.

In a further aspect, a transition enabler determines when the lower rate RF function is permitted to transition between binary states. When the higher rate RF function is repeated for a given cycle, the lower rate RF function may not interfere, and is allowed to transition.

In a further aspect, RF functions may be scaled according to the priority of each signal.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a block diagram of a modulator according to an exemplary embodiment;

FIG. 2 shows a constellation diagram according to an exemplary embodiment;

FIG. 3 shows a constellation diagram according to an exemplary embodiment;

FIG. 4 shows simulated output constellation diagrams according to exemplary embodiments; and

FIG. 5 shows a simulated output power spectrum according to an exemplary embodiment.

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to a communication system and modulator for multiplexing two RF functions onto a shared antenna using a QPSK scheme. Each function is modulated using a BPSK modulation and rotated onto a virtual axis before being combined. A transition enabler determines when the lower rate RF function is permitted to transition between binary states. When the higher rate RF function is repeated for a given cycle, the lower rate RF function may not interfere, and is allowed to transition. RF functions may be scaled according to the priority of each signal.

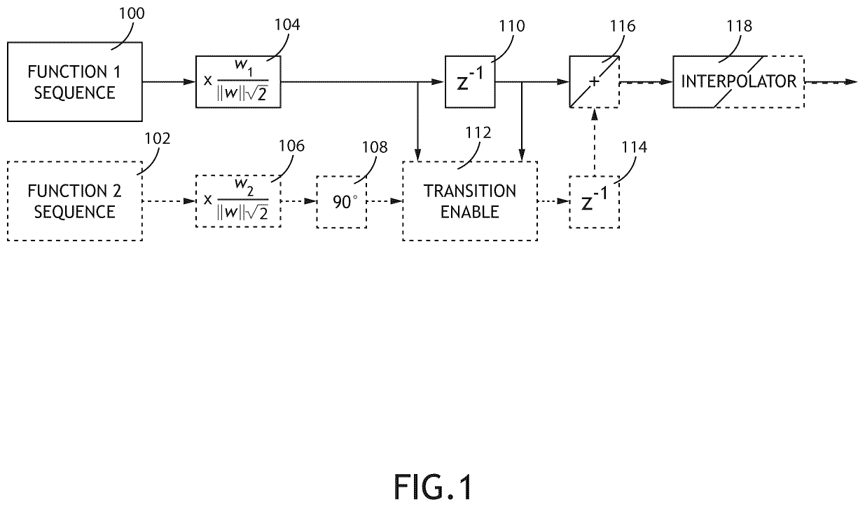

Referring to FIG. 1, a block diagram of a modulator according to an exemplary embodiment is shown. The modulator receives a first RF function sequence 100 and a second RF function sequence 102. Each RF function sequence 100, 102 may define a distinct data rate. The second RF function sequence 102 is phase shifted 90° 108. A 90° shift to the second RF function sequence 102 places the sequence on the imaginary axis. During encoding, the second RF function sequence 102 is delayed by a transition enabling element 112. The transition enabling element 112 receives symbols from the first RF function sequence 100, converts 110 the symbol to a complex representation, and continuously compares a current symbol to the immediately prior symbol. When the current symbol and prior symbol are the same (no transition in the first RF function sequence 100), the transition enabling element 112 allows the second RF function sequence 102 to transition and the next symbol from the second RF function sequence 102 is converted 114 to a complex representation. The converted 110, 114 symbols from the first RF function sequence 100 and second RF function sequence 102 are then combined 116. The resulting signal appears to be a standard QPSK signal, while actually embodying two QPSK signals combined. The combined 116 signal does not have the same properties as two naively combined QPSK signals.

In at least one embodiment, it may be advantageous to establish rate boundaries between the first RF function sequence 100 and second RF function sequence 102. For example, the second RF function sequence 102 may have a maximum rate of no more than 50% of the first RF function sequence 100. RF function sequences 100, 102 may be organized in order of descending rate. Alternatively, or in addition, the firs RF function sequence 100 may define a certain statistical probability of repeated symbols. For example, where the first RF function sequence 100 is known to frequently repeat symbols (though the actual instances of repeats is unpredictable), the first RF function sequence 100 and second RF function sequence 102 may be closer or even equal in rate.

In at least one embodiment, the system may include an interpolator 118 that receives the combined 116 signal and outputs a transmission signal. The interpolator 118 may be embodied in a pulse shaping filter with two samples per symbol.

In at least one embodiment, each of the first RF function sequence 100 and second RF function sequence 102 may be associated with a scaling element 104, 106. Each scaling element 104, 106 adjusts the amplitude of the corresponding RF function sequence 100, 102 while allowing the output to remain fixed on the unit circle. Scaling may be desirable to allow variation in relative quality of service provided to each RF function sequence 100, 102.

For example, a first scaling element 104 may multiply the corresponding first RF function sequence 100 by a by a scaling factor defined by

$$\frac{{w}_{1}}{‖ w ‖ \sqrt{2}} ,$$

and a second scaling element 106 may multiply the corresponding second RF function sequence 102 by a by a scaling factor defined by

$$\frac{{w}_{2}}{‖ w ‖ \sqrt{2}} .$$

In such embodiments, w₁ is a weighting factor the first RF function sequence 100, w₂ is a weighting factor for the second RF function sequence 102, and w={w₂,w₂}.

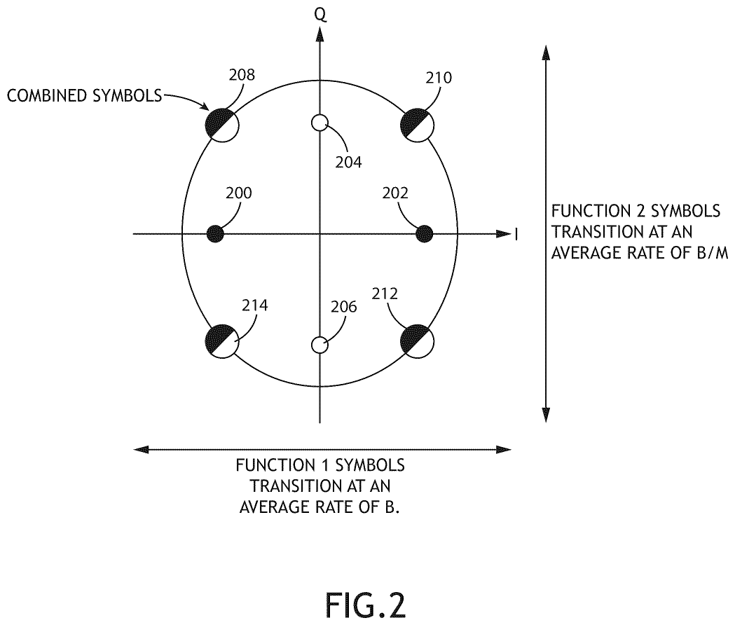

Referring to FIG. 2, a constellation diagram according to an exemplary embodiment is shown. In the constellation diagram for a Multi-rate QPSK (MR-QPSK) system, symbols for a first RF function sequence 200, 202 are represented on the real axis while symbols for a second RF function sequence 204, 206 are represented on the imaginary axis. Combined symbols 208, 210, 212, 214 are represented at 45°±90N. A two function MR-QPSK modulator according to the present disclosure prevents both RF function sequences from transitioning state simultaneously, resulting in a grey coded effect in the combined symbols 208, 210, 212, 214 (i.e., a combined symbol always transitions to a nearest neighbor so that the output signal never crosses the origin).

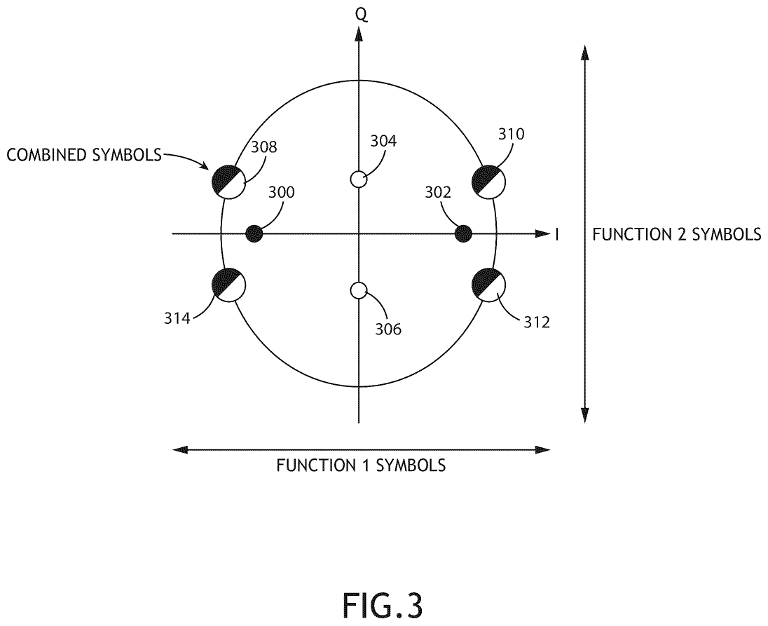

Referring to FIG. 3, a constellation diagram according to an exemplary embodiment is shown. By comparison to the constellation diagram of FIG. 2, symbols for a first RF function sequence 300, 302 may be scaled according to a first weighting factor while symbols for a second RF function sequence 304, 306 are scaled according to a second weighting factor. The corresponding combined symbols 308, 310, 312, 314 are shifted or skewed off of 45°±90N.

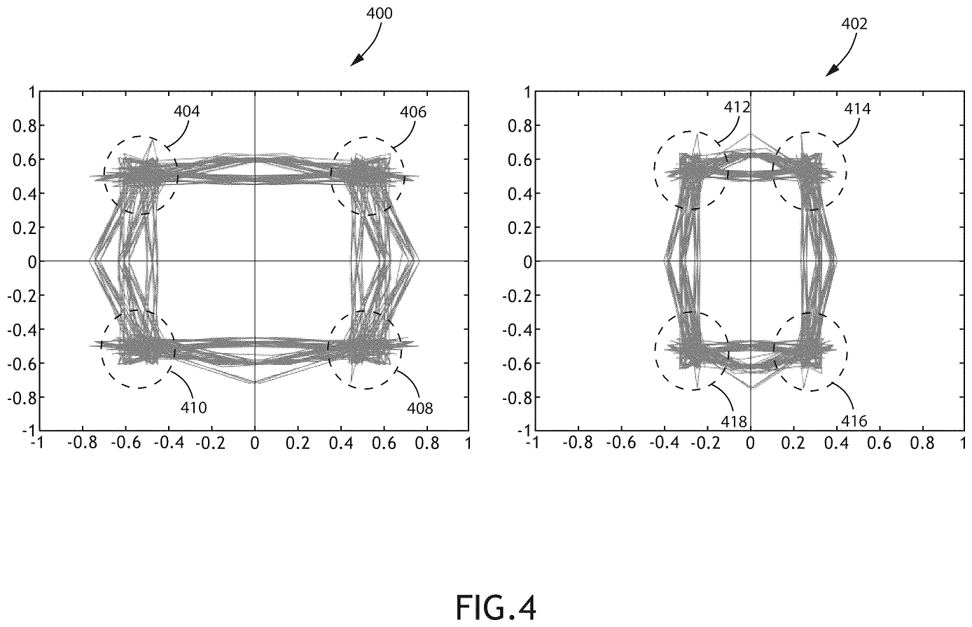

Referring to FIG. 4, simulated output constellation diagrams 400, 402 according to exemplary embodiments are shown. Constellation diagrams 400, 402 for two variations of the MR-QPSK scheme; the first constellation diagram 400 is generated where each RF function sequence is equally weighted and the second constellation diagram 402 showing a skewed or “squinted” QPSK pattern that results from one RF function sequence being weighted more heavily than another.

Each constellation diagram shows combined symbols 404, 406, 408, 410, 412, 414, 416, 418 and the transitions between the combined symbols 404, 406, 408, 410, 412, 414, 416, 418. A transition enabling element allows either of the two embodied RF function sequencies to with no lines passing through the center of the constellation diagram 400, 402.

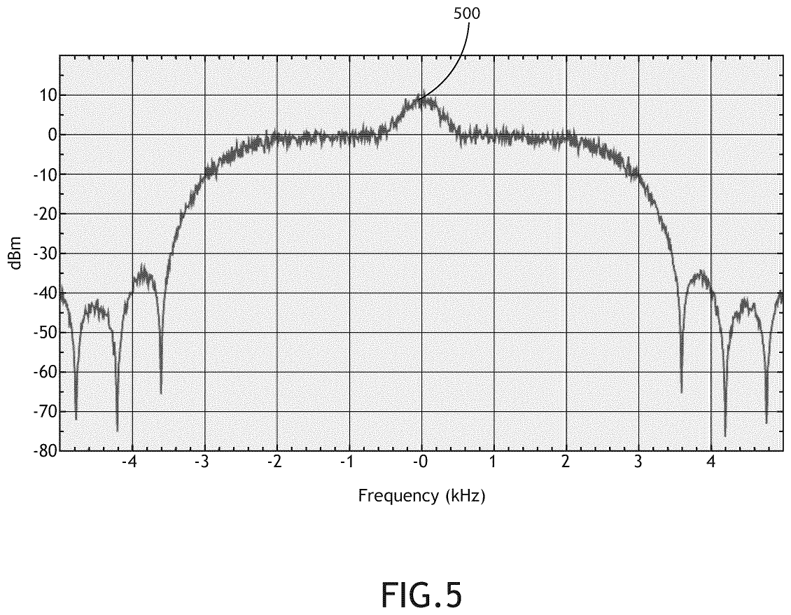

Referring to FIG. 5, a simulated output power spectrum according to an exemplary embodiment is shown. The power spectrum shows two signals added together in frequency domain. A MR-QPSK function according to an exemplary embodiment utilizes a root raised cosine pulse shaping filter with two samples per symbol. The extrusion of energy 500 near zero Hz results from the energy of the slower of the two RF function sequences. The energy spread from approximately −2.5 kHz to 2.5 kHz is a product of the higher bandwidth (faster) RF function sequence. The second RF function sequence has been scaled to have stronger power than the first RF function sequence and it is also more concentrated in the center.

Embodiments of the present disclosure enable MR-QPSK to allow functions of independent rates to be combined. A glitch filtering system may delay symbol transitions of the slower function to ensure they occur at a different time than the faster waveform, allowing the joint-waveform to maintain a nearly constant envelope and ensure a maximum efficiency of the transmitting radio electronics.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. A modulator comprising:
a first symbol converter configured to receive a first signal;
a second symbol converter configured to receive a second signal;
a phase shifter configured to adjust the phase of the second signal;
a combiner; and
a transition enabling element,
wherein:
the transition enabling element is configured to delay a transition of the second signal; and
the combiner is configured to combine a first converted symbol and a second converted symbol into an output with characteristics of a quadrature phase shift keying (QPSK) scheme.

2. The modulator of claim 1, wherein the transition enabling element is configured to delay the transition of the second signal until a symbol of the first signal repeats at least once.

3. The modulator of claim 1, wherein the first signal is at least twice the rate of the second signal.

4. The modulator of claim 1, further comprising at least one scaling element configured to scale an amplitude of the second signal.

5. The modulator of claim 4, wherein the at least one scaling element comprises a second scaling element configured to scale the an amplitude of the first signal.

6. The modulator of claim 1, further comprising an interpolator.

7. The modulator of claim 6, wherein the interpolator comprises a pulse shaping filter configured to perform two samples per symbol.

8. A method of producing a combined output signal comprising:
receiving a first signal via a first symbol converter;
receiving a second signal via a second symbol converter;
adjusting the phase of the second signal via a phase shifter;
combining, via a combiner, a first converted symbol and a second converted symbol into an output with characteristics of a quadrature phase shift keying (QPSK) scheme; and
delaying a transition of the second signal via a transition enabling element.

9. The method of claim 8, wherein delaying the transition comprises comparing a current symbol of the first signal and a prior symbol of the first signal to identify identical symbols.

10. The method of claim 8, wherein the first signal is at least twice the rate of the second signal.

11. The method of claim 8, further comprising scaling an amplitude of the second signal.

12. The method of claim 11, further comprising scaling the an amplitude of the first signal.

13. The method of claim 8, performing two samples per symbol on the output via a pulse shaping filter.

14. A communication system comprising:
a modulator comprising:
a first symbol converter configured to receive a first signal;
a second symbol converter configured to receive a second signal;
a phase shifter configured to adjust the phase of the second signal;
a combiner; and
a transition enabling element,
wherein:
the transition enabling element is configured to delay a transition of the second signal; and
the combiner is configured to combine a first converted symbol and a second converted symbol into an output with characteristics of a quadrature phase shift keying (QPSK) scheme.

15. The communication system of claim 14, wherein the transition enabling element is configured to delay the transition of the second signal until a symbol of the first signal repeats at least once.

16. The communication system of claim 14, wherein the first signal is at least twice the rate of the second signal.

17. The communication system of claim 14, further comprising at least one scaling element configured to scale an amplitude of the second signal.

18. The communication system of claim 17, wherein the at least one scaling element comprises a second scaling element configured to scale the an amplitude of the first signal.

19. The communication system of claim 14, further comprising an interpolator.

20. The communication system of claim 19, wherein the interpolator comprises a pulse shaping filter configured to perform two samples per symbol.
